(19) United States
(12) Patent Application Publication
(10) Pub. No.: US 2022/0191290 A1
(43) Pub. Date: Jun. 16, 2022

(54) METHOD AND APPARATUS FOR ASSISTING SMART DEVICE IN NETWORK COMMUNICATION

(71) Applicant: ZHEJIANG KOUBEI NETWORK TECHNOLOGY CO., LTD., Hangzhou (CN)

(72) Inventor: Ping WANG, Hangzhou (CN)

(21) Appl. No.: 17/680,087

(22) Filed: Feb. 24, 2022

Related U.S. Application Data
(63) Continuation-in-part of application No. PCT/CN2020/082164, filed on Mar. 30, 2020.

(30) Foreign Application Priority Data
Sep. 3, 2019 (CN) 201910829267.4

(51) Int. Cl. H04L 67/141; H04L 69/16; H04L 67/125

(52) U.S. Cl. CPC H04L 67/141; H04L 67/125; H04L 69/16

(57) ABSTRACT

Disclosed are a method and device for assisting a smart device in network communication. The method comprises: at least one smart device is connected to a gateway device by means of a wired connection so that the network device, an assisting terminal, and the at least one smart device are in a same local area network, a TCP connection between the at least one smart device and the assisting terminal is established via the gateway device; the assisting terminal receives a network production request comprising meal production information transmitted by a server, transforms the network production request into a TCP production instruction applicable for the at least one smart device, and transmits to the corresponding smart device, thus allowing the corresponding smart device to complete a corresponding operation on the basis of the TCP production instruction.

### CROSS REFERENCE TO RELATED APPLICATIONS

This application claims priority to Chinese Patent Application No. 201910829267.4 filed on Sep. 3, 2019 and titled “METHOD AND APPARATUS FOR ASSISTING SMART DEVICE IN NETWORK COMMUNICATION”, the entire contents of which are incorporated herein by reference for all purposes.

### TECHNICAL FIELD

The present disclosure relates to the field of communication, in particular to a method and apparatus for assisting a smart device in network communication.

### BACKGROUND

Compared with traditional restaurants, intelligent restaurants can greatly reduce staff costs, process meals more efficiently and controllably, and further carry out quantitative management. The intelligent restaurants can use a mechanical arm for automatically controlling a frying spoon disclosed in a patent document with an application No. 201810758159.8 to drive the frying spoon to simulate an artificial arm in all directions, and move flexibly and accurately. The mechanical arm can not only control the frying spoon to turn vegetables, but also drive the frying spoon to take oil and condiments. Or, for example, a tea industry can use the mechanical arm to make drinks such as milk tea.

However, most of smart devices such as the mechanical arm do not have an ability of accessing a network, as in general, the smart devices can only support Transmission Control Protocol (TCP), cannot directly access the network, and do not have an ability of network communication. If a network communication module is directly added to the smart devices, it is difficult to implement this solution due to a lack of network development experience and ability of device manufacturers of the smart devices. Therefore, it is currently impossible to add the network communication module to the smart devices. Since the smart devices cannot communicate directly with the network, when applying the smart devices to intelligent restaurants, it is also necessary to assist the smart devices to communicate with the network, so that the smart devices can receive orders from the intelligent restaurants and automatically process corresponding meals, thereby improving processing efficiency of the intelligent restaurants.

### SUMMARY

In view of above problems, the present disclosure is proposed to provide a method and apparatus for assisting a smart device in network communication to overcome or at least partially solve the above problems.

According to an aspect of the present disclosure, there is provided a method for assisting a smart device in network communication, applied in an assisting terminal connected to a gateway device, wherein at least one smart device is connected to the gateway device through a wired connection, so that the gateway device, the assisting terminal and the at least one smart device are in a same local area network, the method including:

establishing a TCP connection between the at least one smart device and the assisting terminal through the gateway device;

receiving a network production request including meal production information sent by a server;

transforming the network production request into a TCP production instruction applicable for the at least one smart device, and sending the TCP production instruction to a corresponding smart device, so that the corresponding smart device can complete a corresponding operation according to the TCP production instruction.

According to another aspect of the present disclosure, there is provided an electronic device for assisting a smart device in network communication, including a processor, a memory, a communication interface and a communication bus, wherein the processor, the memory and the communication interface communicate with each other through the communication bus;

the memory is configured to store at least one executable instruction; and

the executable instruction causes the processor to perform following operations:

establishing a TCP connection between the at least one smart device and the assisting terminal through the gateway device;

receiving a network production request including meal production information sent by a server;

transforming the network production request into a TCP production instruction applicable for the at least one smart device, and sending the TCP production instruction to a corresponding smart device, so that the corresponding smart device can complete a corresponding operation according to the TCP production instruction.

According to still another aspect of the present disclosure, there is provided a non-volatile computer readable storage medium having at least one executable instruction stored thereon, wherein the executable instruction causes a processor to perform operations corresponding to the method for assisting the smart device in network communication.

According to yet another aspect of the present disclosure, there is provided a computer program product including a computer program stored on a non-volatile computer storage medium.

According to the method and apparatus for assisting a smart device in network communication provided by the present disclosure, wherein at least one smart device is connected to a gateway device through a wired connection, so that the gateway device, an assisting terminal and the at least one smart device are in a same local area network, a TCP connection between the at least one smart device and the assisting terminal is established through the gateway device; a network production request including meal production information sent by a server is received by the assisting terminal, the network production request is transformed into a TCP production instruction applicable for the at least one smart device, and the TCP production instruction is sent to a corresponding smart device, so that the corresponding smart device can complete a corresponding operation according to the TCP production instruction. By using the assisting terminal to establish the TCP connection with the smart device, a TCP communication between the assisting terminal and the smart device can be facilitated, so that the assisting terminal can receive and transfer the network production request sent by the server, thereby assisting the smart device to respond to the network production request sent by the server to realize the function of communication between the smart device and the network.

The foregoing descriptions are merely an overview of the technical solutions of the present disclosure. To more clearly understand the technical features of the present disclosure, the technical means may be implemented in accordance with the content of the specification. In addition, to make the foregoing and other objectives, features, and advantages of the present disclosure more obvious and easier, detailed implementations of the present disclosure are provided below.

### BRIEF DESCRIPTION OF THE DRAWINGS

Various other advantages and benefits are clear to a person of ordinary skill in the art by reading detailed descriptions of preferred implementations below. The accompanying drawings are merely intended to show the preferred implementations and do not constitute a limitation on the present disclosure. In the whole accompanying drawings, the same reference numeral is used for indicating the same component. In the drawings:

FIG. 1 is a flowchart illustrating a method for assisting a smart device in network communication according to an embodiment of the present disclosure;

FIG. 2 is a flowchart illustrating a method for assisting a smart device in network communication according to another embodiment of the present disclosure;

FIG. 3 is a functional block diagram illustrating an apparatus for assisting a smart device in network communication according to an embodiment of the present disclosure;

FIG. 4 is a schematic structural diagram illustrating an electronic device according to an embodiment of the present disclosure.

### DETAILED DESCRIPTION OF THE EMBODIMENTS

Exemplary embodiments of the present disclosure will be described in more detail below with reference to the accompanying drawings. Although the exemplary embodiments of the present disclosure are shown in the accompanying drawings, it should be understood that the present disclosure can be implemented in various forms and should not be limited by the embodiments set forth herein. Rather, these embodiments are provided to enable a more thorough understanding of the present disclosure and to completely convey the scope of the disclosure to a person skilled in the art.

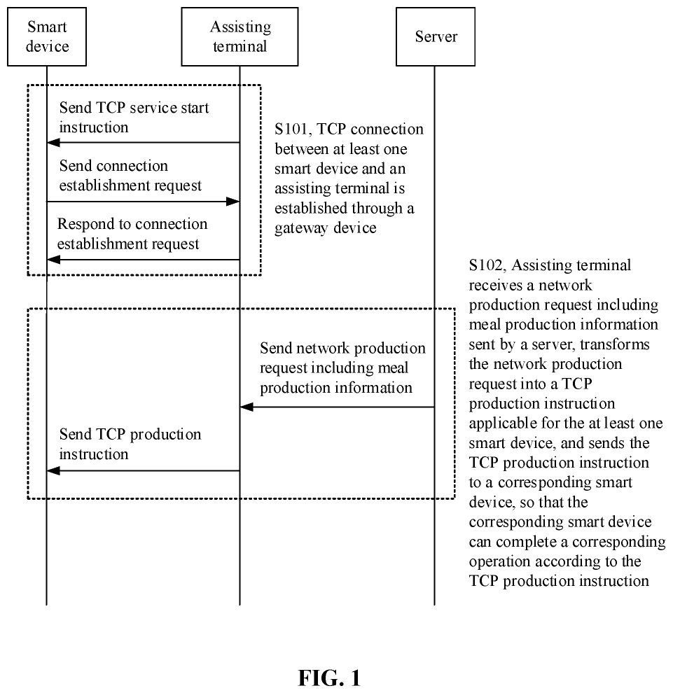

FIG. 1 is a flowchart illustrating a method for assisting a smart device in network communication according to an embodiment of the present disclosure. As shown in FIG. 1, the method for assisting the smart device in network communication specifically includes the following steps.

S101, a TCP connection between at least one smart device and an assisting terminal is established through a gateway device.

The smart device in this embodiment includes smart devices without communication modules, for example, mechanical arms, automatic frying machines, coffee machines, and the like. The smart device can execute instructions in TCP format, but cannot connect to Wi-Fi, and cannot receive network instructions sent by a server. The assisting terminal has a Wi-Fi communication function, and can adopt smart terminals used by merchants daily, for example, merchant management device terminals, kitchen management device terminals, and the like.

Since the smart device cannot directly connect to Wi-Fi, it needs to be connected to the gateway device through a wired connection, for example, a network cable is used to directly connect to the gateway device, or an adapter is used to connect to the gateway device. The assisting terminal can be wirelessly connected to the gateway device, so that the gateway device, the assisting terminal and the at least one smart device are in a same local area network.

The TCP connection between the assisting terminal and the smart device located in the same local area network needs to be established. Specifically, the assisting terminal can send a TCP service start instruction to the at least one smart device through the gateway device, at least one smart device having received the TCP service start instruction sends a connection establishment request to the assisting terminal through the gateway device, and the assisting terminal responds to the connection establishment request and establishes the TCP connection between the at least one smart device and the assisting terminal, thereby facilitating a TCP instruction communication between the smart device and the assisting terminal. Further, the assisting terminal can directionally send the TCP service start instruction to each smart device through the gateway device, for example, the assisting terminal can directionally send the TCP service start instruction to an IP address according to the IP address of each smart device to establish the TCP connection with the smart device corresponding to the IP address. After the TCP connection is established, the assisting terminal can store an object of each smart device that has established the TCP connection, so as to send a TCP instruction to the smart device subsequently.

S102, the assisting terminal receives a network production request including meal production information sent by a server, transforms the network production request into a TCP production instruction applicable for the at least one smart device, and sends the TCP production instruction to a corresponding smart device, so that the corresponding smart device can complete a corresponding operation according to the TCP production instruction.

The assisting terminal can receive the network production request sent by the server, and parse and transform the network production request to obtain the meal production information included in the network production request, for example, milk tea production information, XX dish production information, and the like. The meal production information included in the network production request can be directly set to a TCP production instruction format, so that the assisting terminal can directly obtain the TCP production instruction after parsing the network production request. The meal production information can also be set in other formats such as text information format, so that the assisting terminal can transform the meal production information according to a TCP production instruction conversion rule to obtain a corresponding TCP production instruction. The assisting terminal sends the TCP production instruction to a corresponding smart device, and the smart device completes the corresponding operation according to the TCP production instruction.

Further, different smart devices can produce different meals. When the assisting terminal sends the TCP production instruction to the smart devices, it is also necessary to determine at least one target smart device for responding to the network production request according to the network production request. When determining the target smart device, the target smart device can be determined according to the type of the smart device, the IP address of the smart device, the object of the specified smart device, and the like included in the parsed network production request. After establishing the TCP connection with the smart device, the assisting terminal stores the object of the smart device, so as to determine the target smart device from the stored objects of the smart device according to information such as the type of the smart device, the IP address of the smart device and the object of the specified smart device. After determining the target smart device, the assisting terminal transforms the network production request into a TCP production instruction applicable for the target smart device, and sends the TCP production instruction to the target smart device, so that the target smart device completes the corresponding operation according to the TCP production instruction.

According to the method for assisting a smart device in network communication provided by the present disclosure, wherein at least one smart device is connected to a gateway device through a wired connection, so that the gateway device, an assisting terminal and the at least one smart device are in a same local area network, a TCP connection between the at least one smart device and the assisting terminal is established through the gateway device; a network production request including meal production information sent by a server is received by the assisting terminal, the network production request is transformed into a TCP production instruction applicable for the at least one smart device, and the TCP production instruction is sent to a corresponding smart device, so that the corresponding smart device can complete a corresponding operation according to the TCP production instruction. By using the assisting terminal to establish the TCP connection with the smart device, a TCP communication between the assisting terminal and the smart device can be facilitated, so that the assisting terminal can receive and transfer the network production request sent by the server, thereby assisting the smart device to respond to the network production request sent by the server to realize the function of communication between the smart device and the network.

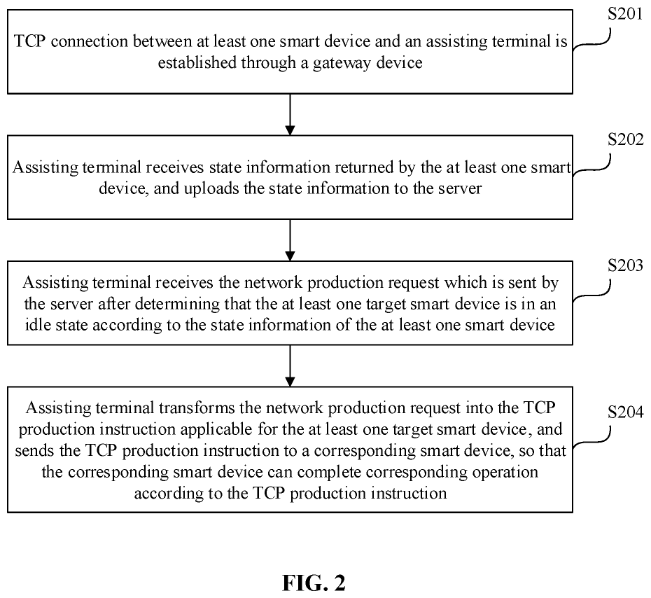

FIG. 2 is a flowchart illustrating a method for assisting a smart device in network communication according to another embodiment of the present disclosure. As shown in FIG. 2, the method for assisting the smart device in network communication specifically includes the following steps.

S201, a TCP connection between at least one smart device and an assisting terminal is established through a gateway device.

The assisting terminal can be connected to the gateway device through a wired or wireless connection, and the smart device can be connected to the gateway device through a wired connection (if the smart device cannot be directly connected to the gateway device, the smart device can be connected to the gateway device by using the adapter). By communicating with the gateway device, the smart device and the assisting terminal are in a same local area network.

Through the gateway device, the assisting terminal establishes the TCP connection with the smart device, so as to transmit a TCP instruction with the smart device subsequently.

S202, the assisting terminal receives state information returned by the at least one smart device, and uploads the state information to the server.

After establishing the TCP connection with the assisting terminal, the smart device can send its state information to the assisting terminal. The state information includes various state information such as a current idle state of the smart device, a meal production state, and a fault state. After receiving the state information transmitted by the smart device, the assisting terminal can upload the state information to the server through a wireless or wired network, so that the server can grasp the current state information of the smart device. A timing of sending the state information by the smart device can be set according to the implementation situation.

S203, the assisting terminal receives the network production request which is sent by the server after determining that the at least one target smart device is in an idle state according to the state information of the at least one smart device.

After receiving the state information of the smart device, the server determines according to the state information of the smart device. When the smart device is in the idle state, that is, the smart device can produce meals, the server sends the network production request to the assisting terminal. If the server determines that the smart device is not in the idle state, for example, the smart device is currently in the meal production state, the network production request can be first placed in a production sequence table pre-established with the cloud, and when it is determined that the smart device is in the idle state, the network production request obtained from the production sequence table is sent to the assisting terminal, so as to ensure that the smart device can produce meals normally when receiving the TCP production instruction, thereby avoiding problems such as production confusion caused by multiple TCP production instructions on the smart device.

S204, the assisting terminal transforms the network production request into the TCP production instruction applicable for the at least one target smart device, and sends the TCP production instruction to a corresponding smart device, so that the corresponding smart device can complete the corresponding operation according to the TCP production instruction.

After receiving the network production request, the assisting terminal transforms the network production request into the TCP production instruction applicable for the smart device. The assisting terminal sends the TCP production instruction to the smart device through the established TCP connection. After receiving the TCP production instruction, the smart device performs the corresponding operation according to the TCP production instruction.

Further, when the method is implemented, steps S202 to S204 are executed circularly according to the implementation situation, thereby enabling the smart device to perform multiple network communications, automatically producing meals in response to the network production request sent by the server, and reducing manual operation cost.

According to the method for assisting a smart device in network communication provided by the present disclosure, the gateway device, the assisting terminal and at least one smart device are in a same local area network, and the TCP connection between the at least one smart device and the assisting terminal is established through the gateway device. The assisting terminal can transfer the received network production request sent by the server, and at the same time, the assisting terminal can also upload the state information sent by the smart device to the server, so as to realize the network communication between the smart device and the server. The present disclosure can realize intelligent communication of the smart device based on the assisting terminal, and improve the processing efficiency of the smart device.

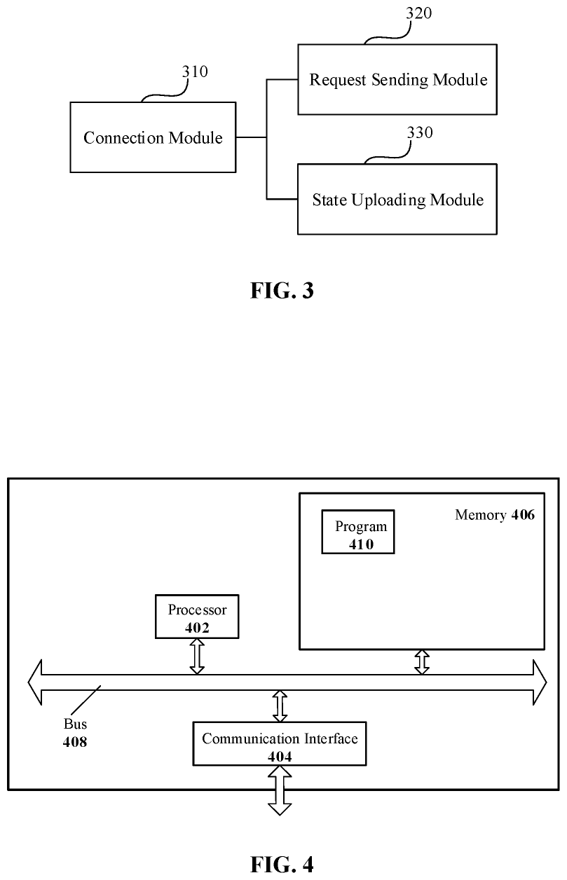

FIG. 3 is a functional block diagram illustrating an apparatus for assisting a smart device in network communication according to an embodiment of the present disclosure. As shown in FIG. 3, the apparatus for assisting the smart device in network communication includes the following modules:

a connection module 310 configured to establish a TCP connection between the at least one smart device and the assisting terminal through the gateway device;

a request sending module 320 configured to receive a network production request including meal production information sent by a server, transform the network production request into a TCP production instruction applicable for the at least one smart device, and send the TCP production instruction to a corresponding smart device, so that the corresponding smart device can complete a corresponding operation according to the TCP production instruction.

Optionally, the connection module 310 is further configured to: send a TCP service start instruction to the at least one smart device in a directional manner through the gateway device; receive a connection establishment request which is sent by at least one candidate smart device having received the TCP service start instruction to the assisting terminal through the gateway device, and establish a TCP connection with the at least one candidate smart device in responding to the connection establishment request.

Optionally, the request sending module 320 is further configured to: receive the network production request sent by the server, and determine at least one target smart device for responding to the network production request; transform the network production request into the TCP production instruction applicable for the at least one target smart device, and send the TCP production instruction to the at least one target smart device, so that the at least one target smart device can complete the corresponding operation according to the TCP production instruction.

Optionally, the apparatus further includes a state uploading module 330.

The state uploading module 330 is configured to receive state information returned by the at least one smart device, and upload the state information to the server.

Optionally, the network production request is sent by the server after determining that the at least one target smart device is in an idle state according to the state information of the at least one smart device.

The descriptions of the above modules refer to the corresponding descriptions in the method embodiments, and details will not be repeated herein.

The present disclosure further provides a non-volatile computer readable storage medium having at least one computer executable instruction stored thereon, where the computer executable instruction can perform the method for assisting the smart device in network communication according to any method embodiment described above.

FIG. 4 is a schematic structural diagram illustrating an electronic device according to an embodiment of the present disclosure. Specific embodiments of the present disclosure do not limit specific implementations of the electronic device.

As shown in FIG. 4, the electronic device may include a processor 402, a communication interface 404, a memory 406 and a communication bus 408.

Wherein:

the processor 402, the communication interface 404 and the memory 406 communicate with each other through the communication bus 408.

The communication interface 404 is configured to communicate with network elements of other devices such as a client or another server.

The processor 402 is configured to execute a program 410, and specifically may perform related steps in the foregoing method for assisting the smart device in network communication.

Specifically, the program 410 may include a program code including a computer operation instruction.

The processor 402 may be a central processing unit (CPU), or an application specific integrated circuit (ASIC), or one or more integrated circuits configured to implement the embodiments of the present disclosure. The electronic device includes one or more processors, which may be the same type of processors, such as one or more CPUs; or may also be different types of processors, such as one or more CPUs and one or more ASICs.

The memory 406 is configured to store the program 410. The memory 406 may include a high-speed random access memory (RAM), or may also include a non-volatile memory, such as at least one disk memory.

The program 410 may be specifically configured to cause the processor 402 to perform the method for assisting the smart device in network communication according to any method embodiment described above. Specific implementations of each step in the program 410 may be performed with reference to the corresponding descriptions of related steps and units in the foregoing embodiment illustrating the method for assisting the smart device in network communication, and details will not be repeated herein. A person skilled in the art may clearly understand that, for convenience and conciseness of the description, the specific operation processes of the above described devices and modules may be performed with reference to the corresponding process descriptions in the foregoing method embodiments, and details will not be repeated herein.

The algorithms and displays provided herein are not inherently related to any particular computer, virtual system, or other device. Various general purpose systems can also be used together with teaching set forth herein. In addition, the present disclosure is not directed to any particular programming language. It should be understood that the content of the present disclosure described herein may be implemented by using various programming languages and the above description of a particular language is to disclose an optimal implementation of the present disclosure.

Numerous details are set forth in the specification provided herein. However, it can be understood that, embodiments in accordance with the present disclosure may be practiced without some details described herein. In some examples, well-known methods and structures are not shown in detail not to obscure the understanding of this specification.

Similarly, it should be understood that in the foregoing description of exemplary embodiments in accordance with the present disclosure, various features of the present disclosure are sometimes grouped together into a single embodiment, a single figure, or description thereof, to simplify the present disclosure and assist in understanding one or more of various aspects of the present disclosure. However, the disclosed method should not be construed as reflecting the intention that the claimed disclosure requires more features than those explicitly recorded in each claim. More definitely, as reflected by the claims, aspects of the present disclosure lie in being less than all features of a single embodiment disclosed above. Therefore, the claims following the Detailed Description are hereby expressly incorporated into the Detailed Description, with each claim standing on its own as a separate embodiment of the present disclosure.

Those skilled in the art can understand that the modules in the devices in the embodiments may be adaptively changed and disposed in one or more devices different from those of the embodiments. Modules or units or components in the embodiments may be combined into one module or unit or component, and in addition, they may be divided into a plurality of sub-modules or sub-units or sub-components. All features disclosed in the present disclosure (including the accompanying claims, abstract and drawings), and all processes or units of any method or device disclosed herein may be combined in any combination, unless at least some of such features and/or processes or units are mutually exclusive. Unless otherwise explicitly stated, each feature disclosed in the present disclosure (including the accompanying claims, abstract and drawings) may be replaced with an alternative feature serving the same, equivalent or similar purpose.

In addition, those skilled in the art can understand that, although some embodiments herein include some but not other features included in other embodiments, combinations of features of different embodiments are meant to be within the scope of the present disclosure and to form different embodiments. For example, in the claims, any one of the claimed embodiments may be used in any combination.

The various component embodiments of the present disclosure may be implemented in hardware or in software modules running on one or more processors or in a combination thereof. Those skilled in the art should understand that a microprocessor or a digital signal processor (DSP) may be used in practice to implement some or all of the functions of some or all of the components of the apparatus for assisting a smart device in network communication according to the embodiments of the present disclosure. The present disclosure may also be implemented as a device or apparatus program (for example, a computer program and a computer program product) for performing part or all of the methods described herein. Such a program implementing the present disclosure may be stored on a computer-readable medium or may have the form of one or more signals. Such signals may be downloaded from Internet websites, provided on carrier signals, or provided in any other form.

It should be noted that the above-mentioned embodiments illustrate rather than limit the present disclosure, and those skilled in the art may devise alternative embodiments without departing from the scope of the appended claims. In the claims, any reference signs placed between parentheses shall not be construed as limiting the claims. The word “comprise” does not exclude the presence of elements or steps not listed in the claims. The word “a” or “an” preceding an element does not exclude the presence of a plurality of such elements. The present disclosure can be implemented by way of hardware including several different elements and an appropriately programmed computer. In the unit claims enumerating several apparatuses, several of these apparatuses can be specifically embodied by the same item of hardware. The use of the words such as “first”, “second”, “third”, and the like does not denote any order. These words can be interpreted as names.

1. A method for assisting a smart device in network communication, wherein at least one smart device is connected to a gateway device through a wired connection, so that the gateway device, an assisting terminal and the at least one smart device are in a same local area network, the method comprising:
establishing a TCP connection between the at least one smart device and the assisting terminal through the gateway device;
receiving, by the assisting terminal, a network production request including meal production information sent by a server, transforming the network production request into a TCP production instruction applicable for the at least one smart device, and sending the TCP production instruction to a corresponding smart device, so that the corresponding smart device can complete a corresponding operation according to the TCP production instruction.

2. The method according to claim 1, wherein establishing the TCP connection between the at least one smart device and the assisting terminal through the gateway device further comprises:
sending, by the assisting terminal, a TCP service start instruction to the at least one smart device in a directional manner through the gateway device;
sending, by at least one smart device having received the TCP service start instruction, a connection establishment request to the assisting terminal through the gateway device;
establishing, by the assisting terminal, a TCP connection with the at least one smart device in responding to the connection establishment request.

3. The method according to claim 1, wherein, receiving, by the assisting terminal, the network production request including meal production information sent by the server, transforming the network production request into the TCP production instruction applicable for the at least one smart device, and sending the TCP production instruction to the corresponding smart device, so that the corresponding smart device can complete the corresponding operation according to the TCP production instruction further comprising:
receiving, by the assisting terminal, the network production request sent by the server, and determining at least one target smart device for responding to the network production request;
transforming the network production request into the TCP production instruction applicable for the at least one target smart device;
sending the TCP production instruction to the at least one target smart device, so that the at least one target smart device can complete the corresponding operation according to the TCP production instruction.

4. The method according to any one of claims 1 to 3, wherein the method further comprises:
receiving, by the assisting terminal, state information returned by the at least one smart device, and uploading the state information to the server.

5. The method according to claim 4, wherein, receiving, by the assisting terminal, the network production request including meal production information sent by the server further comprises:
receiving, by the assisting terminal, the network production request which is sent by the server after determining that the at least one target smart device is in an idle state according to the state information of the at least one smart device.

6. The method according to any one of claims 1 to 5, wherein the assisting terminal comprises at least one of a merchant management device terminal and a kitchen management device terminal.

7. An apparatus for assisting a smart device in network communication, wherein at least one smart device is connected to a gateway device through a wired connection, so that the gateway device, an assisting terminal and the at least one smart device are in a same local area network, the apparatus comprising:
a connection module configured to establish a TCP connection between the at least one smart device and the assisting terminal through the gateway device;
a request sending module configured to receive, by the assisting terminal, a network production request including meal production information sent by a server, transform the network production request into a TCP production instruction applicable for the at least one smart device, and send the TCP production instruction to a corresponding smart device, so that the corresponding smart device can complete a corresponding operation according to the TCP production instruction.

8. The apparatus according to claim 7, wherein the connection module is further configured to:
send, by the assisting terminal, a TCP service start instruction to the at least one smart device in a directional manner through the gateway device;
send, by at least one smart device having received the TCP service start instruction, a connection establishment request to the assisting terminal through the gateway device;
establish, by the assisting terminal, the TCP connection with the at least one smart device in responding to the connection establishment request.

9. The apparatus according to claim 7, wherein the request sending module is further configured to:
receive, by the assisting terminal, the network production request sent by the server, and determine at least one target smart device for responding to the network production request;
transform the network production request into the TCP production instruction applicable for the at least one target smart device, and send the TCP production instruction to the at least one target smart device, so that the at least one target smart device can complete the corresponding operation according to the TCP production instruction.

10. The apparatus according to any one of claims 7 to 9, wherein the apparatus further comprises:
a state uploading module configured to receive, by the assisting terminal, state information returned by the at least one smart device, and upload the state information to the server.

11. The apparatus according to claim 10, wherein the request sending module is further configured to:
receive, by the assisting terminal, the network production request which is sent by the server after determining that the at least one target smart device is in an idle state according to the state information of the at least one smart device.

12. The apparatus according to any one of claims 7 to 11, wherein the assisting terminal comprises at least one of a merchant management device terminal and a kitchen management device terminal.

13. An electronic device, comprising a processor, a memory, a communication interface and a communication bus, wherein
the processor, the memory and the communication interface communicate with each other through the communication bus;
the memory is configured to store at least one executable instruction; and
the executable instruction causes the processor to perform operations corresponding to the method for assisting the smart device in network communication according to any one of claims 1 to 6.

14. A non-volatile computer readable storage medium having at least one executable instruction stored thereon, wherein the executable instruction causes a processor to perform operations corresponding to the method for assisting the smart device in network communication according to any one of claims 1 to 6.

15. A computer program product comprising a computer program stored on a non-volatile computer storage medium, the computer program comprising program instructions which, when executed by a processor, cause the processor to perform operations corresponding to the method for assisting the smart device in network communication according to any one of claims 1 to 6.
